(19) United States
(12) Patent Application Publication
(10) Pub. No.: US 2008/0266226 A1
(43) Pub. Date: Oct. 30, 2008

(54) DISPLAY DEVICE

(75) Inventors: Seung-Beom PARK, Seoul (KR); Jae-Jin LYU, Yongin-si (KR); Myeong-Ha Kye, Seoul (KR); Seung-Ju LEE, Gwangmyeong-si (KR); Yun JANG, Suwon-si (KR); Woo-Jin BAE, Seoul (KR); Seung-Hee LEE, Seoul (KR); Joon-Hyung PARK, Seoul (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 12/037,656

(22) Filed: Feb. 26, 2008

(30) Foreign Application Priority Data
Apr. 27, 2007 (KR) 10-2007-0041482

(51) Int. Cl. G09G 3/36

(52) U.S. Cl. 345/88; 345/102

(57) ABSTRACT

A display device includes a display panel assembly and a backlight assembly. The display panel assembly includes a main panel unit and a sub panel unit facing the main panel unit. The backlight assembly emits light to the display panel assembly. The main panel unit includes a color filter and displays an image in chromatic and achromatic colors, and the sub panel unit displays an image only in an achromatic color.

### CROSS-REFERENCE TO RELATED APPLICATION

This application claims priority from and the benefit of Korean Patent Application No. 10-2007-0041482, filed on Apr. 27, 2007, which is hereby incorporated herein by reference for all purposes as if fully set forth herein.

### BACKGROUND OF THE INVENTION

1. Field of the Invention

The present invention relates to a display device, and more particularly, to a display device that may have improved image quality.

2. Discussion of the Background

There are several kinds of display devices. With the rapid progress of semiconductor technology, displays device including liquid crystal display (LCD) panels have been popular since they are generally small and lightweight.

Display devices including LCD panels have begun to replace conventional cathode ray tubes (CRT) since they are smaller, more lightweight, and consume less power. In recent years, LCD panels have been incorporated in various information processing device ranging from small devices, such as mobile phones, personal digital assistants (PDA), and portable multimedia players (PMP), to medium and large-size devices, such as monitors and TVs.

However, a display device including an LCD panel may have a limited contrast ratio. The larger the display device including the LCD panel, the higher the contrast ratio must be to maintain the image quality. Thus, a conventional display device may use a polarizer or a functional film to improve the contrast ratio. However, such methods may be unable to attain a contrast ratio of 10000:1 and above.

### SUMMARY OF THE INVENTION

The present invention provides a display device that may have improved image quality.

Additional features of the invention will be set forth in the description which follows, and in part will be apparent from the description, or may be learned by practice of the invention.

The present invention discloses a display device including a display panel assembly and a backlight assembly. The display panel assembly includes a main panel unit and a sub panel unit facing the main panel unit. The backlight assembly emits light to the display panel assembly. The main panel unit includes a color filter and displays an image in chromatic and achromatic colors, and the sub panel unit displays an image only in an achromatic color.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a cross-sectional view of a display device according to a first exemplary embodiment of the present invention.

FIG. 2 is an enlarged cross-sectional view of the display panel assembly in FIG. 1.

FIG. 3 is an enlarged cross-sectional view of a display panel assembly that is used in a display device according to a second exemplary embodiment of the present invention.

FIG. 4 is a cross-sectional view of a display device according to a third exemplary embodiment of the present invention.

FIG. 5 is an enlarged cross-sectional view of the display panel assembly in FIG. 4.

FIG. 6 and FIG. 7 show an experimental embodiment according to a third exemplary embodiment of the present invention and a comparative embodiment, respectively.

FIG. 8 is an enlarged cross-sectional view of a display panel assembly that is used in a display device according to a fourth exemplary embodiment of the present invention.

### DETAILED DESCRIPTION OF ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the sizes and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

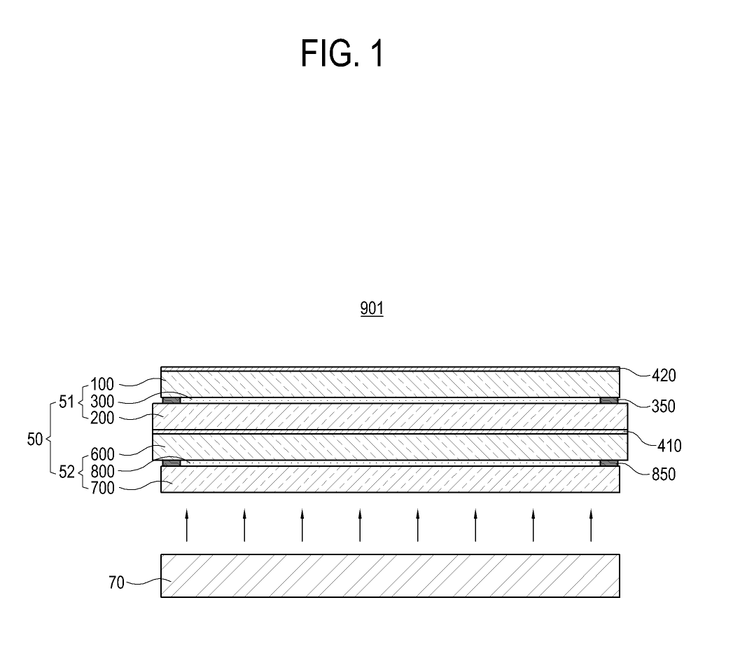

As shown in FIG. 1, a display device 901 according to a first exemplary embodiment of the present invention includes a display panel assembly 50 and a backlight assembly 70 to emit light to the display panel assembly 50.

The backlight assembly 70 uniformly emits light close to a surface of the display panel assembly 50. The backlight assembly 70 may include a lamp unit and an optical member to diffuse light generated by the lamp unit. The lamp unit may include a cold cathode fluorescent lamp (CCFL), an external electrode fluorescent lamp (EEFL), or a hot cathode fluorescent lamp (HCFL).

Alternatively, the backlight assembly 70 may include a surface light source lamp unit, a light emitting diode (LED), or an inorganic light emitting device.

The display device 901 according to the first exemplary embodiment of the present invention may employ other types of backlight assemblies 70.

The display panel assembly 50 includes a main panel unit 51 and a sub panel unit 52 that faces the main panel unit 51. The display panel assembly 50 further includes a first polarizing layer 410, which is disposed on a lower surface of the main panel unit 51, and a second polarizing layer 420, which is disposed on an upper surface of the main panel unit 51. The first polarizing layer 410 is disposed between the main panel unit 51 and the sub panel unit 52.

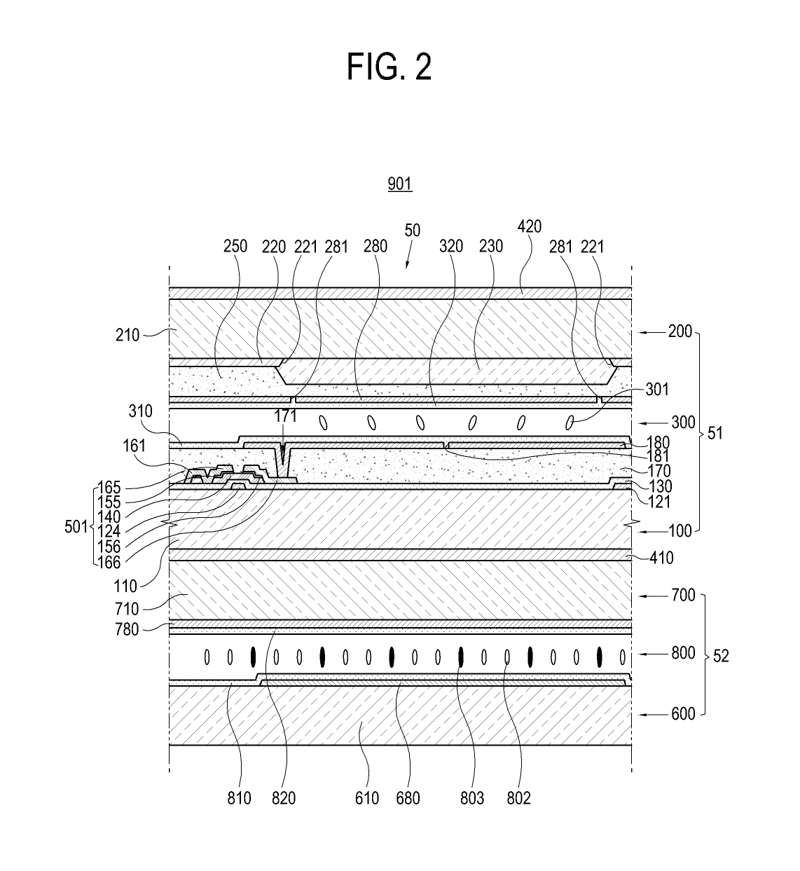

The main panel unit 51 includes a first main panel 100, a second main panel 200 facing the first main panel 100, and a main liquid crystal layer 300 disposed between the first and second main panels 100 and 200. The main panel unit 51 further includes a main sealant 350 that adheres the first and second main panels 100 and 200 to each other and seals the main liquid crystal layer 300. The main panel unit 51 includes a color filter 230 (refer to FIG. 2) that is formed in one of the first and second main panels 100 and 200 and may display an image in chromatic and achromatic colors.

The sub panel unit 52 includes a first sub panel 600, a second sub panel 700 facing the first sub panel 600, and a sub liquid crystal layer 800 disposed between the first and second sub panels 600 and 700. The sub panel unit 52 further includes a sub sealant 850 that adheres the first and second sub panels 600 and 700 to each other, and seals the sub liquid crystal layer 800. The sub panel unit 52 may display an image in an achromatic color. According to the first exemplary embodiment of the present invention, the sub panel unit 52 may display only black and white colors.

The main panel unit 51 and the sub panel unit 52 may display an image with substantially equivalent resolution. A plurality of pixels in the main panel unit 51 corresponds one-to-one with a plurality of pixels in the sub panel unit 52. A pixel refers to the smallest unit displaying an image. The sub panel unit 52 may be synchronized with the main panel unit 51 to be driven.

With the foregoing configuration, the main panel unit 51 may display substantially colorful images while the sub panel unit 52 improves the gray scale ratio, i.e. the contrast ratio of the image displayed by the main panel unit 51.

The display panel assembly 50 will be described in detail with reference to FIG. 2.

First, the main panel unit 51 will be described in detail. The main panel unit 51 is an active matrix (AM) type liquid crystal display panel which uses a thin film transistor (TFT) 501. FIG. 2 shows a main panel unit 51 employing an amorphous silicon (a-Si) thin film transistor 501 formed by five mask processes. Alternatively, the main panel unit 51 may employ different kinds of thin film transistors 501.

Also, the main panel unit 51 may be a liquid crystal display panel in a vertical alignment (VA) mode. In VA mode, the long axis of the liquid crystal molecules is vertically aligned with respect to the substrates in the absence of an electric field. In the liquid crystal display panel in VA mode, a single pixel may be divided into a plurality of domains. In this case, the orientation of the vertically aligned liquid crystal molecules in each domain may be adjusted using a fringe field. Thus, a wide viewing angle may be obtained.

The main panel unit 51 includes a first main panel 100, a second main panel 200, and a main liquid crystal layer 300.

The first main panel 100 includes a first main substrate member 110 and other layers formed on the first main substrate member 110. The first substrate member 110 includes a transparent material such as glass, quartz, ceramic, or plastic.

Gate wires 121 and 124 are formed on the first main substrate member 110. The gate wires 121 and 124 include a plurality of gate lines 121 and a plurality of gate electrodes 124 branched from the gate lines 121. The gate wires 121 and 124 may further include a plurality of first storage electrode lines (not shown).

The gate wires 121 and 124 may include metal such as Al, Ag, Cr, Ti, Ta, and Mo or an alloy thereof. FIG. 2 shows the gate wires 121 and 124 as a single layer. Alternatively, the gate wires 121 and 124 may include multiple metal layers including Cr, Mo, Ti, Ta, or an alloy thereof, which have good physical and chemical properties, and metal layers including Al series metals or Ag series metals, which have small specific resistance. The gate wires 121 and 124 may also include various other metals or conductive materials and may have multiple layers patterned with equivalent etching methods.

A gate insulating layer 130 including silicon nitride (SiNx) is formed on the gate wires 121 and 124.

Data wires 161, 165, and 166 are formed on the gate insulating layer 130. The data wires 161, 165, and 166 include a plurality of data lines 161 perpendicular to the gate lines 121, a plurality of source electrodes 165 branched from the data lines 161, and a plurality of drain electrodes 166 spaced from the source electrodes 165. The data wires 161, 165, and 166 may further include a plurality of second storage electrode lines (not shown) that overlap the first storage electrode lines (not shown).

The data wires 161, 165, and 166 may include a conductive material such as Cr, Mo, Al, or an alloy thereof. The data wires 161, 165, and 166 may include a single layer or multiple layers.

A semiconductor layer 140 is formed on the gate insulating layer 130 of the gate electrodes 124. The semiconductor layer 140 may include amorphous silicon. Here, the gate electrode 124, the source electrode 165, and the drain electrode 166 serve as the three electrodes of the thin film transistor 501. The semiconductor layer 140 formed between the source electrode 165 and the drain electrode 166 is a channel region of the thin film transistor 501.

Ohmic contact layers 155 and 156 are formed between the semiconductor layer 140 and the source electrode 165 and between the semiconductor layer 140 and the drain electrode 166, respectively, to reduce contact resistance therebetween. The ohmic contact layers 155 and 156 may include silicide or amorphous silicon highly doped with an n-type dopant.

A passivation layer 170 is formed on the data wires 161, 165, and 166. The passivation layer 170 may include an insulating material with a low permittivity, such as a-Si:C:O and a-Si:O:F formed by plasma enhanced chemical vapor deposition (PECVD), or an inorganic insulating material, such as silicon nitride or silicon oxide.

An organic layer (not shown) may be formed on the passivation layer 170. The organic layer may be highly planar and photosensitive.

A plurality of main pixel electrodes 180 is formed on the passivation layer 170. The main pixel electrodes 180 may include a transparent conductive material, such as indium tin oxide (ITO) or indium zinc oxide (IZO).

The passivation layer 170 includes a plurality of contact holes 171 that exposes a part of the drain electrodes 166. The main pixel electrodes 180 are connected to the drain electrodes 166 through the contact holes 171.

The size of the main pixel electrode 180 substantially represents the size of a pixel. The main pixel electrode 180 includes a domain dividing part that divides the main pixel electrode 180 into a plurality of domains. As shown in FIG. 2, a first cutting pattern 181 that is partly cut from the main pixel electrode 180 becomes the domain dividing part. Alternatively, the domain dividing part may be formed to include projections.

The second main panel 200 may include a second main substrate member 210 and a plurality of layers formed on the second main substrate member 210. The second main substrate member 210, like the first main substrate member 110, may include a transparent material such as glass, quartz, ceramic, or plastic.

A main light blocking member 220 is formed on the second main substrate member 210 facing the first main substrate member 110. The main light blocking member 220 includes a main opening region 221 facing the main pixel electrode 180 and blocks light leaking between neighboring pixels. The main opening region 221 of the main light blocking member 220 may be substantially smaller than the main pixel electrodes 180. A part of the main light blocking member 220 may be formed corresponding to the thin film transistor 501 to block light incident to the semiconductor layer 140 of the thin film transistor 501.

The main light blocking member 220 may include a metal material or a photosensitive organic material added to a black pigment to block light. The black pigment may include carbon black or titanium oxide.

A color filter 230 having three primary colors is sequentially provided on the second main substrate member 210 having the main light blocking member 220. The color of the color filter 230 is not limited to the three primary colors and may vary as long as it includes at least one color. FIG. 2 shows a color filter 230 formed on the second main substrate member 210, but the color filter 230 is not limited thereto. Alternatively, the color filter 230 may be formed on the first main substrate member 110.

A planarization layer 250 is formed on the main light blocking member 220 and the color filter 230. The planarization layer 250 may be omitted.

A main common electrode 280 is formed on the planarization layer 250 to form an electric field together with the main pixel electrodes 180. The main common electrode 280 may include a transparent conductive material such as ITO or IZO.

The main common electrode 280 also includes a domain dividing part that divides the main common electrode 280 into a plurality of domains. As shown in FIG. 2, a second cutting pattern 281, which is partly cut from the main common electrode 280, becomes the domain dividing part. Alternatively, the domain dividing part may be formed to include projections.

A first main alignment layer 310 and a second main alignment layer 320 are respectively formed on the main pixel electrode 180 and the main common electrode 280 to face each other. The main liquid crystal layer 300 is disposed between the first main alignment layer 310 and the second main alignment layer 320. The main liquid crystal layer 300 includes liquid crystal molecules 301 that are vertically aligned. The first and second main alignment layers 310 and 320 align the long axes of the liquid crystal molecules 301 of the liquid crystal layer 300 in a substantially vertical direction.

With the foregoing configuration, the main panel unit 51 may receive light from the backlight assembly 70 (refer to FIG. 1) and display substantially colorful images.

Hereinafter, the sub panel unit 52 will be described in detail. The sub panel unit 52 includes one of an active matrix type and a passive matrix type liquid crystal display panel. That is, the sub panel unit 52 may be driven by either an active matrix driving method or a passive matrix driving method, as long as it is synchronized with the main panel unit 51.

The sub panel unit 52 may be a guest-host liquid crystal display panel. Since the sub panel unit 52 may display only black and white colors, it may include a guest-host liquid crystal panel that has a relatively simple configuration and a low manufacturing cost. The guest-host liquid crystal display panel may be driven by an active matrix driving method or a passive matrix driving method.

The sub panel unit 52 includes the first sub panel 600, the second sub panel 700, and the sub liquid crystal layer 800.

The first sub panel 600 includes a first sub substrate member 610 and other layers formed on the first sub substrate member 610. The first sub substrate member 610 may include a transparent material such as glass, quartz, ceramic, or plastic.

A sub pixel electrode 680 is formed on the first sub substrate member 610. The sub pixel electrode 680 may include a transparent conductive material such as ITO or IZO. A first sub alignment layer 810 is formed on the sub pixel electrode 680.

If the sub panel unit 52 is an active matrix type, a thin film transistor (not shown) that is connected to the sub pixel electrode 680 is formed on the first sub substrate member 610. The sub pixel electrode 680 is plurally divided and formed in each pixel. In this case, the sub pixel electrodes 680 overlap the main pixel electrodes 180.

The second sub panel 700 includes a second sub substrate member 710 and other layers formed on the second sub substrate member 710. The second sub substrate member 710 may include a transparent material such as glass, quartz, ceramic, or plastic.

A sub common electrode 780 is formed on the second sub substrate member 710. The sub common electrode 780 may include a transparent conductive material such as ITO or IZO. A second sub alignment layer 820 is formed on the sub common electrode 780.

The sub liquid crystal layer 800 is disposed between the first sub alignment layer 810 and the second sub alignment layer 820. The sub liquid crystal layer 800 is a guest-host liquid crystal layer. The guest-host liquid crystal layer includes guest-host liquid crystal molecules 802 that are vertically aligned and dye molecules 803 that are disposed between the liquid crystal molecules 802.

If an electric field is not formed between the sub pixel electrodes 680 and the sub common electrode 780, the long axes of the guest-host liquid crystal molecules 802 are vertically aligned with respect to the sub pixel electrodes 680 and the sub common electrode 780. If the axes of the guest-host liquid crystal molecules 802 are vertically aligned, the pixel allows light to pass through it, thereby displaying white color.

If an electric field is formed between the sub pixel electrodes 680 and the sub common electrode 780, the long axes of the guest-host liquid crystal molecules 802 are aligned parallel to the sub pixel electrodes 680 and the sub common electrode 780. In this case, the dye molecules 803 move in compliance with the movement of the guest-host liquid crystal molecules 802. If the long axes of the guest-host liquid crystal molecules 802 are aligned transversely, the pixel blocks light from passing therethrough, thereby displaying black color.

As described above, the sub panel unit 52 receives light from the backlight assembly 70 (refer to FIG. 1) and may display an image in an achromatic color having black and white colors. The sub panel unit 52 may improve the contrast ratio of the image displayed on the main panel unit 51. In more detail, the sub panel unit 52 may provide dim light by displaying black color to the main pixel electrode 180 displaying a low gray scale image and may provide bright light by displaying white color to the main pixel electrode 180 displaying a high gray scale image.

The main panel unit 51 may be a liquid crystal display panel in VA mode and may require polarizing layers 410 and 420. Thus, the first polarizing layer 410 is disposed on the lower surface of the first main panel 100 while the second polarizing layer 420 is disposed on the upper surface of the second main panel 200. The polarizing axes of the polarizers of the first and second polarizing layers 410 and 420 are perpendicular to each other. Because the sub panel unit 52 includes a guest-host liquid crystal display panel, it does not require polarizing layers.

According to the first exemplary embodiment of the present invention, the sub panel unit 52 may be a guest-host liquid crystal panel, but is not limited thereto. Alternatively, the sub panel unit 52 may vary as long as it displays an image in black and white colors. For example, the sub panel unit 52 may include a liquid crystal display panel that has a relatively simple configuration and provides high productivity.

With the foregoing configuration, the display device 901 may have improved image quality. That is, the display device 901 may display an image through a display panel assembly 50 having a pair of panel units 51 and 52 that perform different operations. More specifically, the display panel assembly 50 includes a main panel unit 51 to substantially display an image and a sub panel unit 52 to improve the contrast ratio of the image displayed on the main panel unit 51. Thus, the display device 901 may display an image having relatively high contrast ratio.

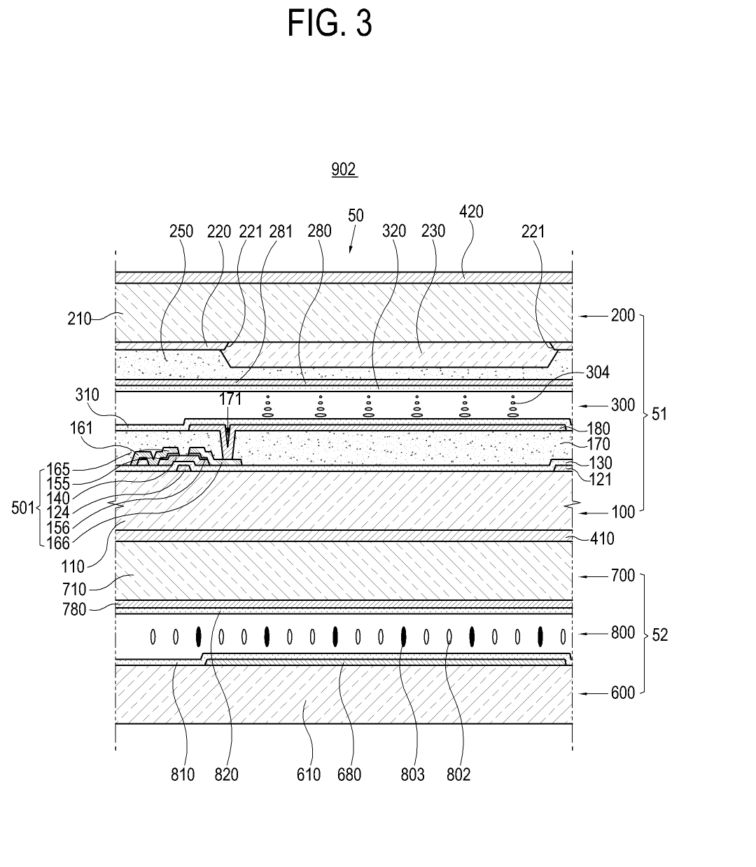

Referring to FIG. 3, a display device according to a second exemplary embodiment of the present invention will be described.

As shown therein, a display device 902 includes a liquid crystal display panel in a twisted nematic (TN) mode as a main panel unit 51.

The main panel unit 51 is an active matrix type liquid crystal display panel that uses a thin film transistor 501. FIG. 3 shows the main panel unit 51 that uses an amorphous silicon (a-Si) thin film transistor 501 formed by five mask processes. Alternatively, the main panel unit 51 may employ various types of thin film transistors 501.

A main pixel electrode 180 and a main common electrode 280 do not include a domain dividing part such as a cutting pattern or a projection. A main liquid crystal layer 300 includes TN mode liquid crystal molecules 304.

A first main alignment layer 310 and a second main alignment layer 320 align the long axes of the TN mode liquid crystal molecules 304 of the liquid crystal layer 300 to be parallel to the main pixel electrode 180 and the main common electrode 280 while twisting the central axes of the TN mode liquid crystal molecule 304.

The main panel unit 51 in TN mode has a narrower viewing angle than that in the vertically aligned mode, but responds more quickly. Also, the TN mode main panel unit 51 has a simple configuration and manufacturing process and therefore, may provide high productivity. The display device 902 according to the second exemplary embodiment of the present invention may further include a functional film, such as a wide viewing angle compensation film, in addition to the polarizing layers 410 and 420, which may improve the viewing angle of the main panel unit 51.

A sub panel unit 52 includes one of an active matrix type and a passive matrix type liquid crystal display panel. That is, the sub panel unit 52 may be driven either by an active matrix driving method or by a passive matrix driving method as long as it is synchronized with the main panel unit 51.

FIG. 3 shows a guest-host liquid crystal display panel as the sub panel unit 52. Since the sub panel unit 52 may display only black and white colors, it may include a guest-host liquid crystal panel that has relatively a simple configuration and a low manufacturing cost. The guest-host liquid crystal display panel may be driven by an active matrix driving method or a passive matrix driving method.

According to the second exemplary embodiment of the present invention, the sub panel unit 52 is the guest-host liquid crystal panel, but is not limited thereto. Alternatively, the sub panel unit 52 may vary as long as it displays an image in black and white colors. For example, the sub panel unit 52 may have a relatively simple configuration and may provide high productivity.

With the foregoing configuration, the display device 902 may have improved image quality. That is, the display device 902 may display an image through the display panel assembly 50 having a pair of panel units 51 and 52 that perform different operations. More specifically, the display panel assembly 50 includes the main panel unit 51 to display an image and the sub panel unit 52 to improve the contrast ratio of the image displayed on the main panel unit 51. Thus, the display device 902 may display an image having a relatively high contrast ratio.

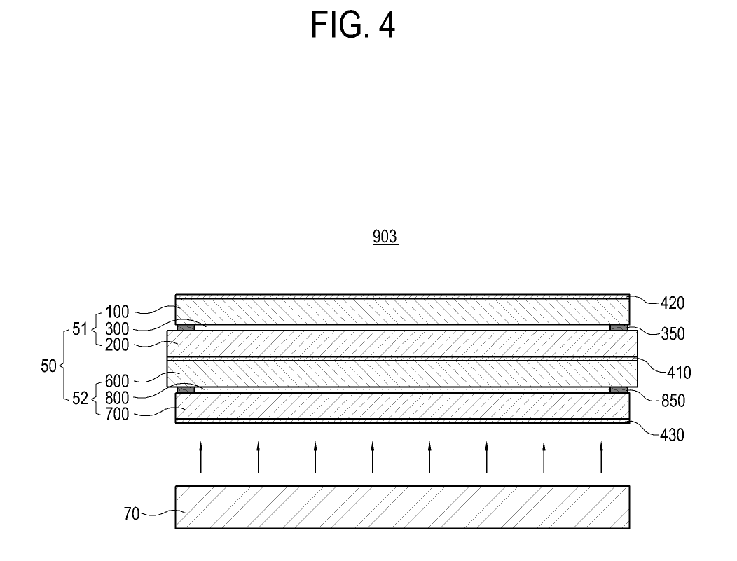

Referring to FIG. 4, a display device according to a third exemplary embodiment of the present invention will be described.

As shown therein, a display device 903 according to the third exemplary embodiment of the present invention may include a display panel assembly 50 and a backlight assembly 70 that emits light to the display panel assembly 50.

The display panel assembly 50 includes a main panel unit 51 and a sub panel unit 52 that faces the main panel unit 51. The display panel assembly 50 further includes a first polarizing layer 410 that is disposed on a lower surface of the main panel unit 51, a second polarizing layer 420 that is disposed on a upper surface of the main panel unit 51, and a third polarizing layer 430 that is disposed on a lower surface of the sub panel unit 52. The first polarizing layer 410 is disposed between the main panel unit 51 and the sub panel unit 52. Here, a polarizing axis of a polarizer in the first polarizing layer 410 is perpendicular to those of the second polarizing layer 420 and the third polarizing layer 430. Polarizing axes of the polarizers in the second and third polarizing layers 420 and 430 are parallel to each other.

The sub panel unit 52 is disposed between the main panel unit 51 and the backlight assembly 70.

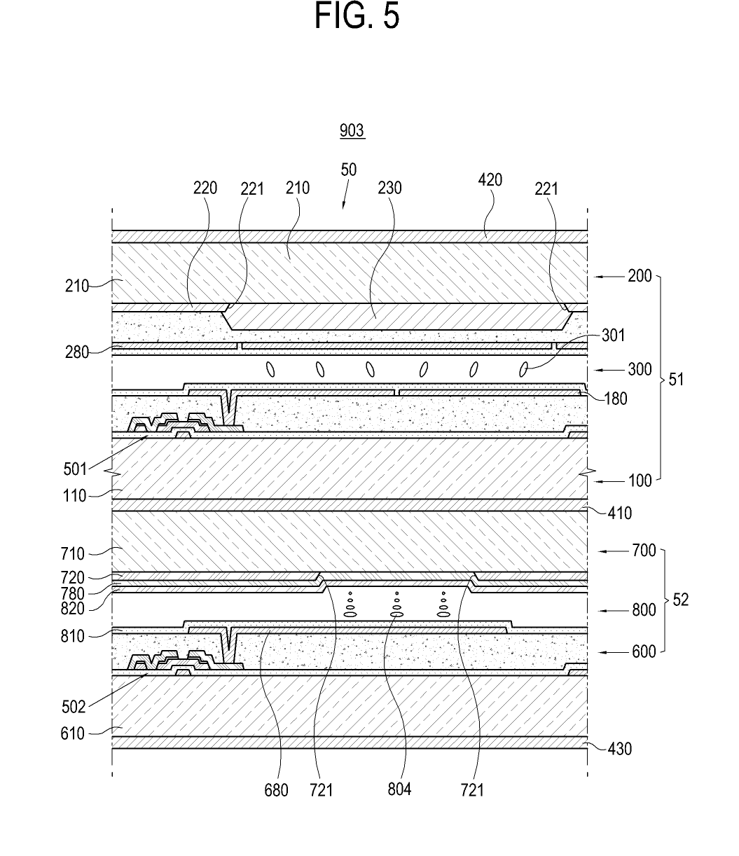

The main panel unit 51 includes a first main panel 100, a second main panel 200 facing the first main panel 100, and a main liquid crystal layer 300 disposed between the first and second main panels 100 and 200. The main panel unit 51 further includes a main sealant 350 that adheres the first and second main panels 100 and 200 to each other and seals the main liquid crystal layer 300. The main panel unit 51 includes a color filter 230 (refer to FIG. 5) that is formed in one of the first and second main panels 100 and 200 and may display an image in chromatic and achromatic colors.

The sub panel unit 52 includes a first sub panel 600, a second sub panel 700 facing the first sub panel 600, and a sub liquid crystal layer 800 disposed between the first and second sub panels 600 and 700. The sub panel unit 52 further includes a sub sealant 850 that adheres the first and second sub panels 600 and 700 to each other and seals the sub liquid crystal layer 800. The sub panel unit 52 may display an image in only an achromatic color. According to the third exemplary embodiment of the present invention, the sub panel unit 52 may display only black and white colors.

The main panel unit 51 and the sub panel unit 52 may display an image with substantially equivalent resolution. A plurality of pixels in the main panel unit 51 corresponds one-to-one with a plurality of pixels in the sub panel unit 52.

With the foregoing configuration, the main panel unit 51 may display colorful images while the sub panel unit 52 may improve the gray scale ratio, i.e. the contrast ratio, of the image displayed by the main panel unit 51.

The display panel assembly 50 will be described in detail with reference to FIG.

As described above with reference to FIG. 1, the main panel unit 51 is an active matrix (AM) type liquid crystal display panel that uses a thin film transistor (TFT) 501. The main panel unit 51 includes a liquid crystal display panel in VA mode.

The main panel unit 51 includes a first main panel 100, a second main panel 200, and a main liquid crystal layer 300. The first main panel 100 includes a main thin film transistor 501 and a main pixel electrode 180. The second main panel 200 includes a main light blocking member 220, a main common electrode 280, and a color filter 230. Alternatively, the color filter 230 may be formed in the first main panel 100.

The main light blocking member 220 includes a plurality of main opening regions 221 through which light passes from the backlight assembly 70 (refer to FIG. 4). Main opening regions 221 of the main light blocking member 220 correspond to the main pixel electrode 180. The main opening regions 221 may be substantially smaller than the main pixel electrode 180.

The sub panel unit 52 is a liquid crystal display panel in a twisted nematic (TN) mode. The sub panel unit 52 is one of an active matrix type or a passive matrix type liquid crystal display panel. That is, the sub panel unit 52 may be driven by either an active matrix driving method or a passive matrix driving method as long as it is synchronized with the main panel unit 51. FIG. 5 shows an active matrix type sub panel unit 52 that uses a thin film transistor 502.

The sub panel unit 52 includes a first sub panel 600, a second sub panel 700, and a sub liquid crystal layer 800. The first sub panel 600 includes a sub thin film transistor 502 and a sub pixel electrode 680. The second sub panel 700 includes a sub light blocking member 720 and a sub common electrode 780. That is, the sub panel unit 52 does not include a color filter.

The sub light blocking member 720 includes a plurality of sub opening regions 721 through which light passes from the backlight assembly 70 (refer to FIG. 4). The sub opening regions 721 of the sub light blocking member 720 correspond to a center of the main opening regions 221 of the main light blocking member 220. Also, the sub opening regions 721 of the sub light blocking member 720 correspond to the sub pixel electrode 680. The sub opening regions 721 may be substantially smaller than the sub pixel electrode 680. The main opening regions 221 of the main light blocking member 220 may be larger than the sub opening regions 721 of the sub light blocking member 720.

Thus, the sub openings 721 may be smaller than the main openings 221, which may be smaller than the main pixel electrode 180.

The main pixel electrode 180 corresponds one-to-one with the sub pixel electrode 680 and overlaps the sub pixel electrode 680. That is, the main panel unit 51 and the sub panel unit 52 may display an image with substantially equivalent resolution.

With the foregoing configuration, the display device 903 may improve the contrast ratio of an image displayed on the display panel assembly 50 and while reducing light leakage. Also, the display device may improve visibility and the viewing angle.

Light that passes through the sub opening regions 721 of the sub panel unit 52 may be restrained from passing through main opening regions 221 other than the main openings 221 of the main panel unit 51 that correspond to the concerned sub opening regions 721. That is, the pixel of the main panel unit 51 and the pixel of the sub panel unit 52 may correspond to each other regardless of the viewing angle.

If the main panel unit 51 overlaps the sub panel unit 52 to form a display panel 50 having an improved the contrast ratio, the overall thickness of the display panel assembly 50 may increase. Thus, a pixel of the main panel unit 51 may correspond to different pixels of the sub panel unit 52 at different viewing angles. That is, light which is emitted by the backlight assembly 70 (refer to FIG. 4) and passes through a pixel of the sub panel unit 52 may pass through a neighboring pixel instead of the pixel of the main panel unit 51 that corresponds to the pixel of the sub panel unit 52, thereby causing light leakage.

According to the third exemplary embodiment of the present invention, the sub opening regions 721 of the sub light blocking member 720 in the sub panel unit 52 disposed between the main panel unit 51 and the backlight assembly 70 may be smaller than the main opening regions 221 of the main light blocking member 220 in the main panel unit 51, which may restrain light from leaking to neighboring pixels.

Thus, light leakage may be restrained and lateral visibility may be improved.

According to the third exemplary embodiment of the present invention, the main panel unit 51 is an active matrix type liquid crystal display panel in VA mode, but is not limited thereto. Alternatively, the main panel unit 51 may include other kinds of liquid crystal display panels including a liquid crystal display panel in TN mode.

According to the third exemplary embodiment of the present invention, the sub panel unit 52 may include an active matrix type liquid crystal display panel in TN mode, but is not limited thereto. Alternatively, the sub panel unit 52 may include other kinds of liquid crystal display panels including a liquid crystal display panel in VA mode and a guest-host liquid crystal display panel. The sub panel unit 52 may be driven by either an active matrix driving method or a passive matrix driving method as long as it is synchronized with the main panel unit 51.

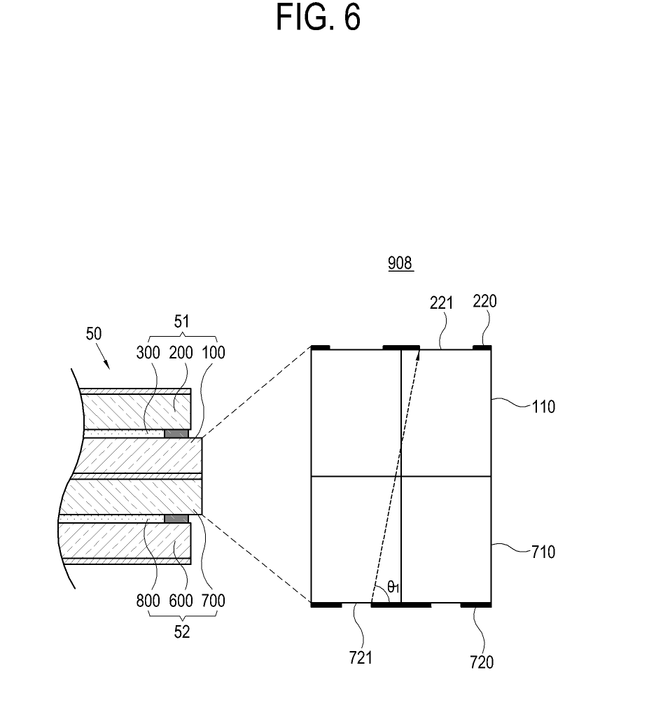

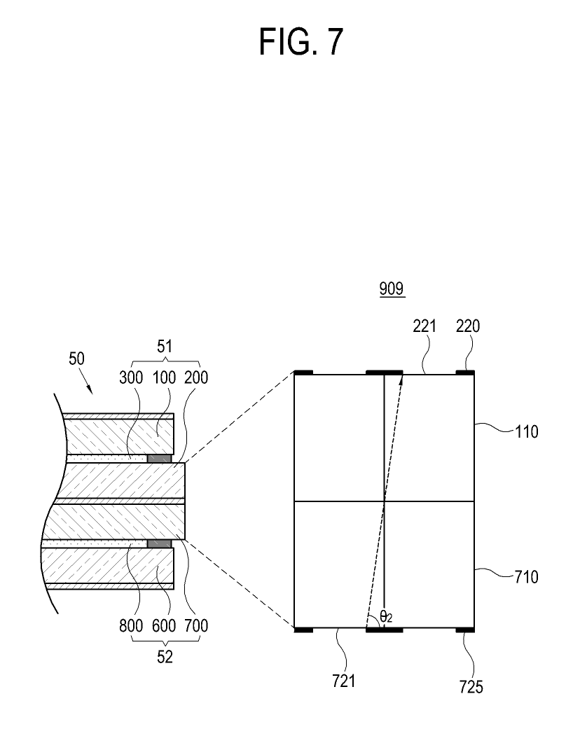

Hereinafter, the third exemplary embodiment of the present invention will be described in detail through an experimental embodiment. FIG. 6 and FIG. 7 show the experimental embodiment according to the third exemplary embodiment of the present invention and a comparative embodiment. Such an experimental embodiment exemplifies the present invention, but the present invention is not confined thereto.

### Experimental Embodiment

To simulate the third exemplary embodiment of the present invention, an experimental display device 908 according to the experimental embodiment includes a main light blocking member 220 having a main opening region 221, a first main substrate member 110 of a first main panel 100, a sub light blocking member 720 having a sub opening region 721, and a second sub substrate member 710 of a second sub panel 700, which are disposed as shown in FIG. 6. Other elements that do not influence the experimental result or rarely influence the experimental result are omitted.

Here, the sub opening region 721 is smaller than the main opening region 221. A main pixel electrode 180 (not shown) that has a size close to that of a pixel displaying an image is formed to be larger than the main opening region 221.

FIG. 6 shows an arrow that refers to an optical path of light. The smallest angle of inclination at which light leakage does not occur in the experimental embodiment is referred to as θ1.

### Comparative Embodiment

To simulate the third exemplary embodiment of the present invention, a comparative display device 909 according to the comparative embodiment includes a main light blocking member 220 having a main opening region 221, a first main substrate member 110 of a first main panel 100, a sub light blocking member 720 having a sub opening region 721, and a second sub substrate member 710 of a second sub panel 700, which are disposed as shown in FIG. 7. Other elements that do not influence the experimental result or rarely influence the experimental result are omitted.

Here, the size of the main opening region 221 may be substantially equivalent to that of the sub opening region 721. A main pixel 180 (not shown) that has a size close to that of a pixel displaying an image is formed to be larger than the main opening region 221.

FIG. 7 shows an arrow that refers to an optical path of light. The smallest angle of inclination at which light leakage does not occur in the comparative embodiment is referred to as θ2.

As shown in FIG. 6 and FIG. 7, light leakage may occur more easily in the comparative embodiment than in the experimental embodiment. That is, light leakage does not occur in the experimental embodiment when viewing at an angle larger than θ1. Also, visibility is not lowered. Meanwhile, light leakage occurs in the comparative embodiment when viewing at an angle less than θ2. Since θ1 is smaller than θ2, the experimental embodiment provides an improved viewing angle as compared to the comparative embodiment.

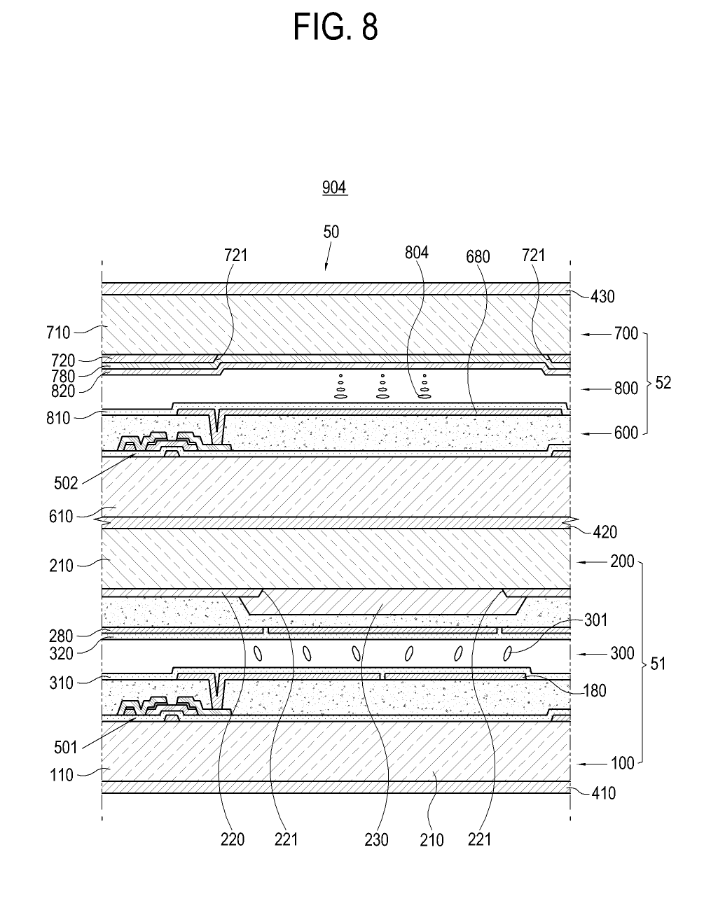

Referring to FIG. 8, a display device according to a fourth exemplary embodiment of the present invention will be described.

As shown therein, a display device 904 according to the fourth exemplary embodiment of the present invention includes a main panel unit 51 disposed between a sub panel unit 52 and a backlight assembly 70 (refer to FIG. 4). A display panel assembly 50 includes the main panel unit 51 that displays an image and the sub panel unit 52 that is disposed on the main panel unit 51.

The display panel assembly 50 further includes a first polarizing layer 410 that is disposed on a lower surface of the main panel unit 51, a second polarizing layer 420 that is disposed on a upper surface of the main panel unit 51, and a third polarizing layer 430 that is disposed on a upper surface of the sub panel unit 52. The second polarizing layer 420 is disposed between the main panel unit 51 and the sub panel unit 52. Here, a polarizing axis of a polarizer in the second polarizing layer 420 is perpendicular to those of the polarizers in the first polarizing layer 410 and the third polarizing layer 430. The polarizing axes of the polarizers in the first and third polarizing layers 410 and 430 are parallel to each other.

The main panel unit 51 includes a first main panel 100, a second main panel 200 facing the first main panel 100, and a main liquid crystal layer 300 disposed between the first and second main panels 100 and 200. The main panel unit 51 includes a color filter 230 (refer to FIG. 2), which is formed in one of the first and second main panels 100 and 200, and may display an image in chromatic and achromatic colors.

The sub panel unit 52 includes a first sub panel 600, a second sub panel 700 facing the first sub panel 600, and a sub liquid crystal layer 800 disposed between the first and second sub panels 600 and 700. The sub panel unit 52 may display an image only in an achromatic color. According to the fourth exemplary embodiment of the present invention, the sub panel unit 52 may display only black and white colors.

The main panel unit 51 and the sub panel unit 52 may display an image with substantially equivalent resolution. A plurality of pixels in the main panel unit 51 corresponds one-to-one with a plurality of pixels in the sub panel unit 52.

With the foregoing configuration, the main panel unit 51 may display colorful images while the sub panel unit 52 may improve the gray scale ratio, i.e. the contrast ratio, of the image displayed by the main panel unit 51.

Hereinafter, the display panel assembly 50 will be described in detail.

The main panel unit 51 is an active matrix (AM) type liquid crystal display panel that uses a thin film transistor (TFT) 501. The main panel unit 51 is a liquid crystal display panel in VA mode.

The main panel unit 51 includes a first main panel 100, a second main panel 200, and a main liquid crystal layer 300. The first main panel 100 includes a main thin film transistor 501 and a main pixel electrode 180. The second main panel 200 includes a main light blocking member 220, a main common electrode 280, and a color filter 230. Alternatively, the color filter 230 may be formed in the first main panel 100.

The main light blocking member 220 includes a plurality of main opening regions 221 through which light passes from the backlight assembly 70 (refer to FIG. 4). The main opening regions 221 of the main light blocking member 220 correspond to the main pixel electrode 180. The main opening regions 221 may be substantially smaller than the main pixel electrode 180.

The sub panel unit 52 includes a liquid crystal display panel in TN mode. The sub panel unit 52 is one of an active matrix type or a passive matrix type liquid crystal display panel. That is, the sub panel unit 52 may be driven by either an active matrix driving method or a passive matrix driving method as long as it is synchronized with the main panel unit 51. FIG. 8 shows an active matrix type sub panel unit 52 that uses a thin film transistor 502.

The sub panel unit 52 includes a first sub panel 600, a second sub panel 700, and a sub liquid crystal layer 800. The first sub panel 600 includes a sub thin film transistor 502 and a sub pixel electrode 680. The second sub panel 700 includes a sub light blocking member 720 and a sub common electrode 780. That is, the sub panel unit 52 does not include a color filter.

The sub light blocking member 720 includes a plurality of sub opening regions 721 through which light passes from the backlight assembly 70 (refer to FIG. 4). The sub opening regions 721 of the sub light blocking member 720 correspond to a center of the main opening regions 221 of the main light blocking member 220. Also, the sub opening regions 721 of the sub light blocking member 720 correspond to the sub pixel electrode 680. The sub opening regions 721 may be substantially smaller than the sub pixel electrode 680. The main opening regions 221 of the main light blocking member 220 may be smaller than the sub opening regions 721 of the sub light blocking member 720.

That is, according to the fourth exemplary embodiment of the present invention, the sub opening regions 721 may be larger than the main opening regions 221, unlike in the third exemplary embodiment. More specifically, the opening regions of the light blocking member in one of the main and sub panel units 51 and 52 adjacent to the backlight assembly 70 may be smaller than those of the other.

With the foregoing configuration, the display device 904 may improve the contrast ratio of an image displayed on the display panel assembly 50 and restrain light leakage, which may enhance visibility and improve the viewing angle.

Light which passes through the main opening regions 221 of the main panel unit 51 may be restrained from passing through sub opening regions 721 other than the sub opening regions 721 of the sub panel unit 52 that correspond to the concerned main opening regions 221. That is, the pixel of the main panel unit 51 and the pixel of the sub panel unit 52 may correspond to each other regardless of the viewing angle of the display panel assembly 50.

If the main panel unit 51 overlaps the sub panel unit 52 to form a display panel 50 having an improved contrast ratio, the overall thickness of the display panel assembly 50 may increase. Thus, the pixel of the main panel unit 51 may correspond to different pixels of the sub panel unit 52 at different viewing angles. Thus, light that is emitted by the backlight assembly 70 (refer to FIG. 4) and passes through a pixel of the main panel unit 51 may pass through a neighboring pixel instead of the pixel of the sub panel unit 52 that corresponds to the pixel of the main panel unit 51, thereby causing light leakage.

According to the fourth exemplary embodiment of the present invention, the main opening regions 221 of the main light blocking member 220 in the main panel unit 51 disposed between the sub panel unit 52 and the backlight assembly 70 may be smaller than the sub opening regions 721 of the sub light blocking member 720 in the sub panel unit 52, which may restrain light from leaking to neighboring pixels.

Thus, light leakage may be restrained and lateral visibility may be improved.

According to the fourth exemplary embodiment of the present invention, the main panel unit 51 is an active matrix type liquid crystal display panel in VA mode, but is not limited thereto. Alternatively, the main panel unit 51 may include other kinds of liquid crystal display panels including a liquid crystal display panel in TN mode.

According to the fourth exemplary embodiment of the present invention, the sub panel unit 52 is an active matrix type liquid crystal display panel in TN mode, but is not limited thereto. Alternatively, the sub panel unit 52 may include other kinds of liquid crystal display panels including a liquid crystal display panel in VA mode and a guest-host liquid crystal display panel. The sub panel unit 52 may be driven by either an active matrix driving method or a passive matrix driving method as long as it is synchronized with the main panel unit 51.

As described above, exemplary embodiments of the present invention provide a display device that may have improved image quality. The display device displays an image through a display panel assembly having a pair of panel units that perform different operations. More specifically, the display panel assembly includes a main panel unit to substantially display an image and a sub panel unit to improve the contrast ratio of the image displayed by the main panel unit. Thus, the display device may display an image with a relatively high contrast ratio.

Because the contrast ratio of the image displayed by the display panel assembly may be improved while light leakage is restrained, visibility may be enhanced and the viewing angle may be improved.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A display device, comprising:
a display panel assembly comprising a main panel unit and a sub panel unit facing the main panel unit; and
a backlight assembly to emit light to the display panel assembly,
wherein the main panel unit comprises a color filter and displays an image in chromatic and achromatic colors and
wherein the sub panel unit displays an image only in an achromatic color.

2. The display device of claim 1, wherein the main panel unit comprises an active matrix (AM) type liquid crystal display panel.

3. The display device of claim 2, further comprising:
a first polarizing layer disposed on a lower surface of the main panel unit; and
a second polarizing layer disposed on an upper surface of the main panel unit.

4. The display device of claim 3, wherein the liquid crystal display panel is in a vertical alignment (VA) mode.

5. The display device of claim 3, wherein the liquid crystal display panel is in a twisted nematic (TN) mode.

6. The display device of claim 2, wherein the sub panel unit comprises one of an active matrix type liquid crystal display panel and a passive matrix type liquid crystal display panel.

7. The display device of claim 6, wherein the sub panel unit displays only black and white colors.

8. The display device of claim 7, wherein the sub panel unit comprises a guest-host liquid crystal display panel.

9. The display device of claim 7, further comprising a third polarizing layer disposed on a surface of the sub panel unit not facing the main panel unit.

10. The display device of claim 9, wherein the sub panel unit comprises a liquid crystal display panel in twisted nematic (TN) mode.

11. The display device of claim 9, wherein the sub panel unit comprises a liquid crystal display panel in a vertical alignment (VA) mode.

12. The display device of claim 2, wherein the main panel unit comprises a main light blocking member comprising a plurality of main opening regions to pass light from the backlight assembly therethrough, and
the sub panel unit comprises a sub light blocking member comprising a plurality of sub opening regions respectively corresponding to a center of the main opening regions of the main light blocking member.

13. The display device of claim 12, wherein the main display panel further comprises:
a main common electrode,
a plurality of main pixel electrodes corresponding to the main opening regions of the main light blocking member, and
a main liquid crystal layer disposed between the main common electrode and the main pixel electrodes, and
wherein the sub display panel further comprises:
a sub common electrode,
a plurality of sub pixel electrodes corresponding to the sub opening regions of the sub light blocking member, and
a sub liquid crystal layer disposed between the sub common electrode and the sub pixel electrodes.

14. The display device of claim 13, wherein the main pixel electrodes overlap the sub pixel electrodes.

15. The display device of claim 14, wherein the main panel unit and the sub panel unit display an image with substantially equivalent resolution.

16. The display device of claim 14, wherein the sub panel unit is disposed between the main panel unit and the backlight assembly.

17. The display device of claim 16, wherein the main opening regions of the main light blocking member are larger than the sub opening regions of the sub light blocking member.

18. The display device of claim 17, wherein the main opening regions of the main light blocking member are smaller than the main pixel electrodes.

19. The display device of claim 14, wherein the main panel unit is disposed between the sub panel unit and the backlight assembly.

20. The display device of claim 19, wherein the main opening regions of the main light blocking member are smaller than the sub opening regions of the sub light blocking member.

21. The display device of claim 20, wherein the sub opening regions of the sub light blocking member are smaller than the sub pixel electrodes.
